(19) United States
(12) Patent Application Publication
(10) Pub. No.: US 2024/0402022 A1
(43) Pub. Date: Dec. 5, 2024

(54) INPUT DEVICE AND FORCE DETECTOR USING FORCE SENSOR FOR DETECTING MOMENT

(71) Applicant: Makoto SHIDA, Tokyo (JP)

(72) Inventor: Makoto SHIDA, Tokyo (JP)

(73) Assignee: MITSUMI ELECTRIC CO., LTD., Tokyo (JP)

(21) Appl. No.: 18/673,956

(22) Filed: May 24, 2024

(30) Foreign Application Priority Data
May 31, 2023 (JP) 2023-089883
Feb. 16, 2024 (JP) 2024-022243

(51) Int. Cl. G01L 1/00

(52) U.S. Cl. CPC G01L 1/005

(57) ABSTRACT

An input device includes a force input unit, a detection unit, and a sensor that detects a force on the detection unit. The detection unit includes a first input unit and a second input unit disposed on respective sides of the sensor in a first direction. The sensor detects a change in a positional relationship between the first input unit and the second input unit. The positional relationship changes in accordance with torsional movement about a first axis along the first direction.

### CROSS-REFERENCE TO RELATED APPLICATIONS

This application claims priority under 35 U.S.C. § 119 to Japanese Patent Application Nos. 2023-089883, filed May 31, 2023, and 2024-022243, filed Feb. 16, 2024, the contents of which are incorporated herein by reference in their entirety.

### BACKGROUND

### 1. Technical Field

The present disclosure relates to an input device and a force detector.

### 2. Description of the Related Art

An apparatus capable of detecting pressure on, for example, a curved substrate is known (see Patent Document 1).

### RELATED-ART DOCUMENT

### Patent Document

Patent Document 1: Japanese Unexamined Patent Application Publication No. 2015-190863

### SUMMARY

An input device in the present disclosure is provided. The input device includes a force input unit continuous along a first direction, a detection unit coupled to the force input unit in the first direction, and a sensor provided on the detection unit and configured to detect a force on the detection unit, the detection unit including a sensor mount on which the sensor is provided, the sensor mount including a first plane along the first direction and a second direction intersecting the first direction. The detection unit includes a first input unit and a second input unit disposed on respective sides of the sensor in the first direction, each of the first input unit and the second input unit being coupled to the sensor mount, and including a second plane facing the sensor. The sensor is configured to detect a change in a positional relationship between the first input unit and the second input unit. The positional relationship changes in accordance with torsional movement about a first axis along the first direction.

A force sensor in the present disclosure is provided. The force sensor includes a detection unit coupled to a force input unit in a first direction, and a sensor provided on the detection unit and configured to detect a force on the detection unit, the detection unit including a sensor mount on which the sensor is provided, the sensor mount including a first plane along the first direction and a second direction intersecting the first direction. The detection unit includes a first input unit and a second input unit disposed on respective sides of the sensor in the first direction, each of the first input unit and the second input unit being coupled to the sensor mount, and including a second plane facing the sensor. The sensor is configured to detect a change in a positional relationship between the first input unit and the second input unit. The positional relationship changes in accordance with torsional movement about a first axis along the first direction.

### BRIEF DESCRIPTION OF THE DRAWINGS

FIG. 1 is a perspective view of an example of an input device according to a first embodiment.

FIG. 2 is a cross-sectional perspective view of an example of a detection unit with a sensor.

FIG. 3 is of a perspective view of an example of the detection unit with the sensor.

FIG. 4 is a plan view of an example of an input device according to a second embodiment.

FIG. 5 is a diagram showing directions of a force Fx along an X-axis, a force Fy along a Y-axis, a force Fz along a Z-axis, a moment Mx about the X-axis, a moment My about the Y-axis, and a moment Mz about the Z-axis.

FIG. 6 is a perspective view of an example of a force sensor device according to an embodiment.

FIG. 7 is a perspective view of an example of a sensor chip, a flexible substrate, and a strain-generating unit.

FIG. 8 is a cross-sectional perspective view of an example of the strain-generating unit of the force sensor device.

FIG. 9 is a diagram showing an application example of the input device according to the first embodiment.

FIGS. 10A to 10C are diagrams showing examples of force detection of the input device according to the first embodiment.

FIG. 11 is a diagram showing the application example of the input device according to the second embodiment.

FIG. 12 is a perspective view of an example of the input device according to a third embodiment.

FIG. 13 is a plan view of an example of the input device according to the third embodiment.

FIG. 14 is a front view of an example of the input device according to the third embodiment.

FIG. 15 is a perspective view of an example of the detection unit with the sensor according to the third embodiment.

### DETAILED DESCRIPTION

The inventor of this application has recognized that an apparatus in related art cannot detect torsion of a first axis that extends in a first direction.

In view of the situation recognized by the inventor, an object of the present disclosure is to provide an input device and a force detector that are capable of detecting torsion of a first axis that extends in a first direction.

Hereinafter, an input device and a force detector according to various embodiments will be described with reference to the drawings. In the present specification and the drawings, substantially the same components may be denoted by the same numerals, and duplicate description may be omitted. Although the term “above” or “below” may be used in the description of the embodiments, arrangement of the input device and the force detector is not limited to the examples illustrated below. For example, the input device and the force detector may be used by vertically inverting the input device and the force detector shown in any figure.

### Input Device According to First Embodiment

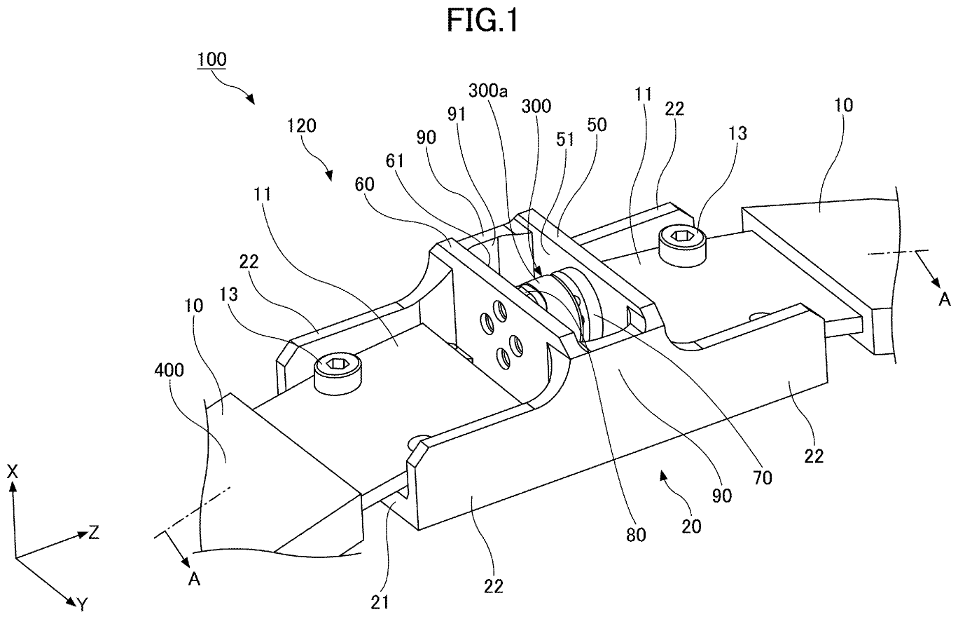

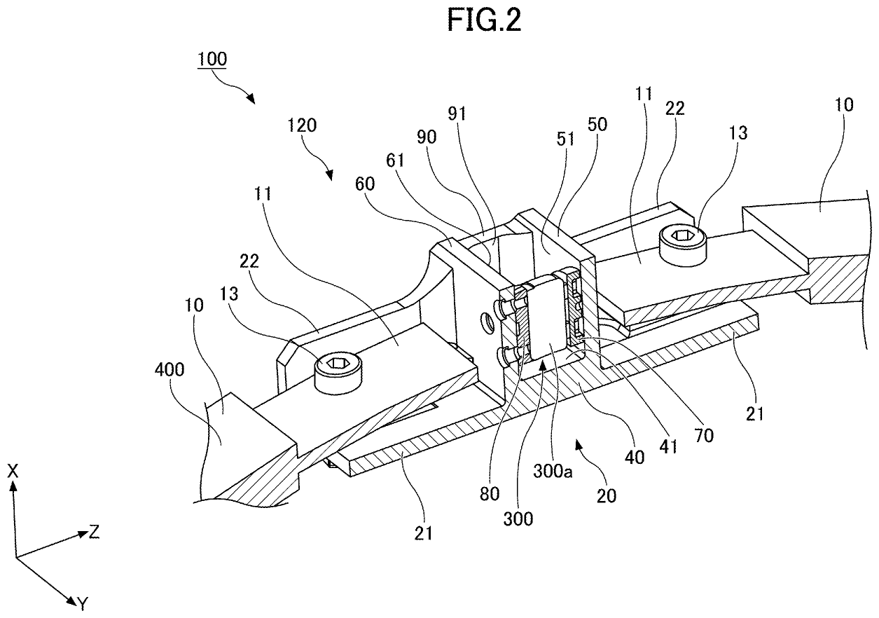

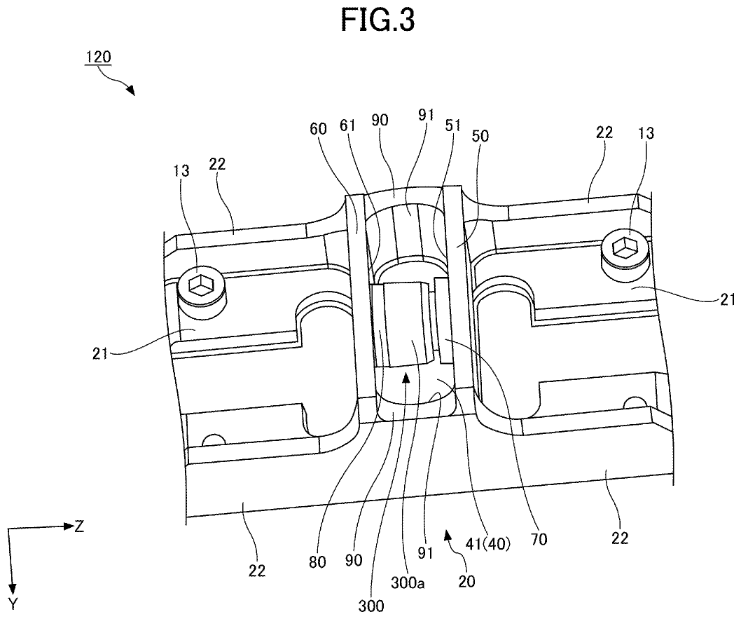

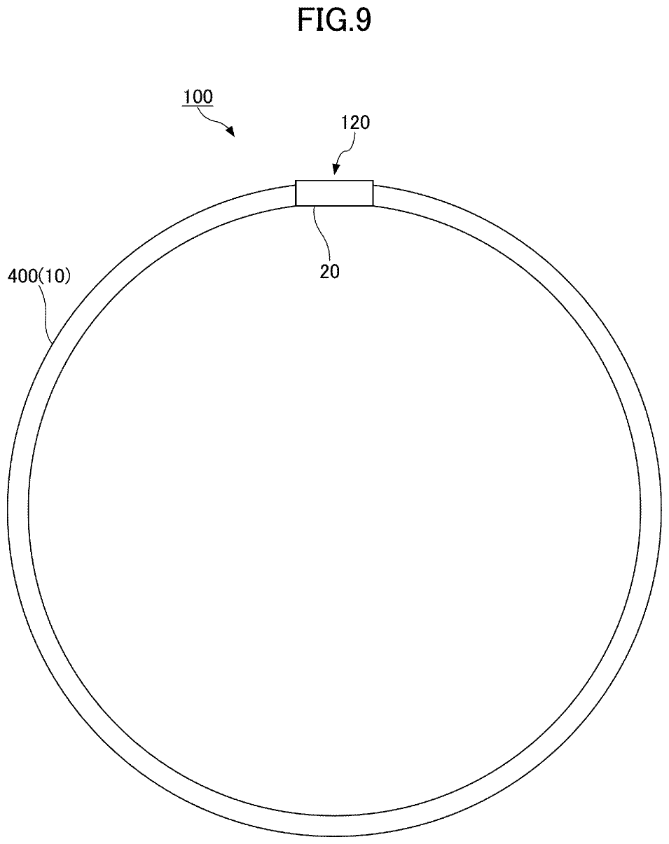

An input device 100 according to a first embodiment will be described with reference to FIGS. 1 to 3 and 9. FIG. 1 is a perspective view of an example of the input device 100 according to the first embodiment. FIG. 2 is a cross-sectional perspective view of an example of a detection unit 20 with a sensor 300. FIG. 2 corresponds to a cross section taken along the line A-A in FIG. 1. FIG. 3 is a perspective view of an example of the detection unit 20 with the sensor 300. FIG. 9 is a diagram showing an application example of the input device 100 according to the first embodiment. For reference, an X axis, a Y axis, and a Z axis that are orthogonal to one another are illustrated in FIGS. 1 to 3. The X axis, the Y axis, and the Z axis are illustrated as needed in other figures. The X axis, the Y axis, and the Z axis may not be mutually orthogonal. An XY plane is a plane along the X axis and the Y axis. An XZ plane is a plane along the X axis and the Z axis. A YZ plane is a plane along the Y axis and the Z axis.

As shown in FIGS. 1 and 2, the input device 100 includes a force input unit 10, the detection unit 20, and a sensor 300. The input device 100 can detect a force that acts on the force input unit 10. The input device 100 may be applied to a rim 400 of a bicycle wheel, for example, as shown in FIG. 9. For example, the force input unit 10 may be a portion of the rim 400. The input device 100 is a device that can enter an input related to an input operation that is to be performed on an electronic device, for example. The input device 100 may be used as a device for entering an input related to the input operation that is performed on any other machine, device, or the like.

### Input Unit

The force input unit 10 has a predetermined length. The force input unit 10 is continuous along a Z-axis direction. The Z-axis direction is an example of a first direction. The first direction may refer to a longitudinal direction of the force input unit 10. As shown in FIG. 9, the force input unit 10 is disposed, for example, along the circumference of a circle when viewed in a Y-axis direction. The force input unit 10 has an arcuate shape. In the longitudinal direction, the detection unit 20 is coupled at both end portions 11 of the force input unit 10. Each end portion 11 has, for example, a plate shape. The end portions 11 are, for example, fixed to the detection unit 20 by respective bolts 13 of the detection unit 20. The end portions 11 may be fixed to the detection unit 20 by a plurality of bolts 13.

### Force Detector

The input device 100 includes a force detector 120. The force detector 120 includes the detection unit 20 and the sensor 300.

### Detection Unit

The detection unit 20 is connected to the force input unit 10 in the Z-axis direction. The force acting on the force input unit 10 is transmitted to the detection unit 20. As shown in FIGS. 2 and 3, the detection unit 20 includes a sensor mount 40, a first input unit 50, and a second input unit 60. The detection unit 20 includes buffer portions 90, bottom plates 21, and side plates 22.

### Sensor Mount 40

The sensor mount 40 includes a plane 41. The plane 41 is an example of a first plane. The plane 41 includes the YZ plane. The plane 41 includes a plane along the Z-axis direction and the Y-axis direction. The plane 41 may be a plane perpendicular to the X-axis direction. The Y-axis direction is an example of a second direction. The X-axis direction is an example of a third direction. The Y-axis direction may be a direction that is along a centerline of the force input unit 10 that has a ring shape. The X-axis direction may be a direction that is along a radial direction of the ring-shaped force input unit 10.

The sensor mount 40 has a plate shape, for example. A plate thickness direction of the sensor mount 40 is along the X-axis direction. The plane 41 faces the sensor 300 in the X-axis direction. The plane 41 is a plane of the sensor mount 40 that is close to the sensor 300.

### First Input Unit 50 and Second Input Unit 60

Each of the first input unit 50 and the second input unit 60 has a plate shape, for example. The first input unit 50 and the second input unit 60 face each other in the Z-axis direction. The first input unit 50 and the second input unit 60 are connected to the sensor mount 40. The first input unit 50 and the second input unit 60 extend from the sensor mount 40 in the X-axis direction. The first input unit 50 and the second input unit 60 are disposed on respective sides of the sensor 300 in the Z-axis direction. A plate thickness direction of each of the first input unit 50 and the second input unit 60 is along the Z-axis direction.

The first input unit 50 includes a plane 51. The second input unit 60 includes a plane 61. The planes 51 and 61 are examples of a second plane. Each of the planes 51 and 61 includes the XY plane. The planes 51 and 61 are opposed to each other in the Z-axis direction. The sensor 300 is disposed between the planes 51 and 61.

A length of each of the first input unit 50 and the second input unit 60 along the Y-axis direction is larger than a width of the sensor 300 along the Y-axis direction. A length of each of the first input unit 50 and the second input unit 60 is larger than a width of the sensor 300 in the X-axis direction. The sensor 300 is interposed between the first input unit 50 and the second input unit 60 in the Z-axis direction.

The first input unit 50 is fixed to a first detection unit 70 of the sensor 300 described below, by one or more screws, for example. The sensor 300 is fixed to the second input unit 60 by one or more screws, for example. In the Z-axis direction, the planes 51 and 61 are in contact with the sensor 300. The first input unit 50 and the second input unit 60 can deform in response to the force that is transmitted from the force input unit 10. The force transmitted from the force input unit 10 is transmitted to the sensor 300 through the first input unit 50 and the second input unit 60.

### Buffer Portion 90

Each buffer portion 90 has a plate shape. A thickness direction of the buffer portions 90 is along the Y-axis direction. The buffer portions 90 are each coupled to the first input unit 50 and the second input unit 60 in the Z-axis direction. The buffer portions 90 making a pair are opposed to each other in the Y-axis direction. The pair of buffer portions 90 protrudes from the sensor mount 40 in the X-axis direction. In the X-axis direction, the plane 41 in the sensor mount 40 is present in a region that is surrounded by the first input unit 50, the second input unit 60, and the pair of buffer portions 90. The sensor 300 is arranged between the buffer portions 90 of the pair in the Y-axis direction. Each of the buffer portions 90 making the pair is spaced apart from the sensor 300 in the Y-axis direction.

The buffer portion 90 includes a plane 91. The plane 91 includes the XZ plane. The plane 91 is an example of a third plane. The plane 91 may be a plane in the buffer portion 90 that is close to the sensor 300 in the Y-axis direction.

### Bottom Plate 21 and Side Plate 22

As shown in FIG. 2, the detection unit 20 includes the bottom plates 21 and the side plates 22. A thickness direction of each bottom plate 21 is along the X-axis direction. The bottom plates 21 are disposed on respective sides of the sensor mount 40 in the Z-axis direction. Each bottom plate 21 extends from the sensor mount 40 in the Z-axis direction. The bottom plate 21 includes a support surface for supporting the end portions 11 of the force input unit 10. The end portions 11 of the force input unit 10 are fixed to the bottom plate 21. The end portions 11 are fixed to the bottom plate 21 by respective bolts 13, for example. The sensor mount 40 is thicker than the bottom plate 21. The bottom plate 21 is deformable in response to a force transmitted from the force input unit 10. The force transmitted to the bottom plate 21 is transmitted to the sensor 300 via the first input unit 50 and the second input unit 60.

A thickness direction of each side plate 22 is along the Y-axis direction. Given side plates 22 are arranged on respective sides of the buffer portion 90 in the Z-axis direction. The given side plates 22 are connected to a corresponding buffer portion 90 via each of the first input unit 50 and the second input unit 60. The given side plates 22 are arranged at respective ends of the corresponding bottom plate 21 in the Y-axis direction. The given side plates 22 extend from the corresponding bottom plate 21 in the X-axis direction. Each side plate 22 extends from a corresponding input unit among the first input unit 50 and the second input unit 60 in the Z-axis direction. The given side plates 22 making a pair face each other in the Y-axis direction. The corresponding bottom plate 21 and the pair of side plates 22 form a recess in which the end portion 11 of the force input unit 10 is disposed. The side plates 22 making the pair are spaced apart in the Y-axis direction.

A plate thickness of the side plate 22 may be the same as that of each of the bottom plate 21, the first input unit 50, the second input unit 60, and the buffer portion 90. The term “same” is intended to cover the meaning “substantially the same.” A length of the side plate 22 along the X-axis direction may be smaller than a length of each of the first input unit 50, the second input unit 60, and the buffer portion 90 that is along the X-axis direction.

### Sensor 300

The sensor 300 is mounted on the detection unit 20. The sensor 300 can detect a force acting on the detection unit 20. The sensor 300 can detect the force acting on the first input unit 50 and the second input unit 60. The sensor 300 is, for example, a force sensor. The force sensor is described below in detail. The sensor 300 is not limited to the force sensor. The sensor 300 may include, for example, a capacitance sensor, a strain gauge, an optical sensor, or a magnetic sensor. The sensor 300 includes, for example, a sensor body 300a with a sensor chip.

### First Detection Unit

The sensor 300 includes a first detection unit 70. The first detection unit 70 is disposed between the sensor body 300a and the first input unit 50 in the Z-axis direction. The first detection unit 70 has a disk shape, for example. The first detection unit 70 contacts the first input unit 50 in the Z-axis direction. The first detection unit 70 contacts the plane 51.

### Second Detection Unit

The sensor 300 includes a second detection unit 80. The second detection unit 80 is disposed between the sensor body 300a and the second input unit 60 in the Z-axis direction. The second detection unit 80 has a disk shape, for example. The second detection unit 80 contacts the second input unit 60 in the Z-axis direction. The second detection unit 80 contacts the plane 61.

### Detection by Sensor

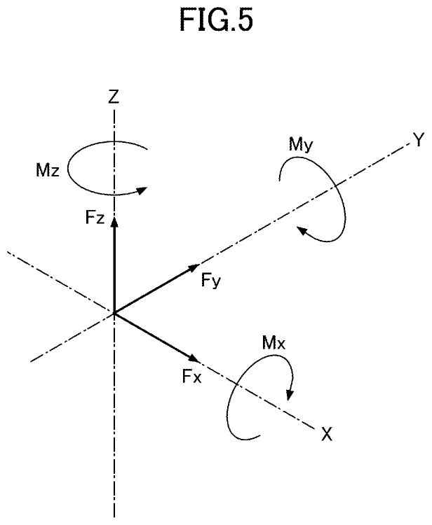

FIG. 5 is a diagram showing the directions of the force Fx along the X-axis, the force Fy along the Y-axis, the force Fz along the Z-axis, the moment Mx about the X-axis, the moment My about the Y-axis, and the moment Mz about the Z-axis. The sensor 300 can detect, for example, the force Fx in the X-axis direction, the force Fy in the Y-axis direction, and the force Fz in the Z-axis direction. The sensor 300 can detect the moment Mx to cause rotation about the X-axis, the moment My to cause rotation about the Y-axis, and the moment Mz to cause rotation about the Z-axis.

In each figure, the X-axis direction, the Y-axis direction, and the Z-axis direction may be expressed by respective arrows. The X-axis direction, the Y-axis direction, and the Z-axis direction are illustrated with reference to the sensor 300. For example, when the orientation of the sensor 300 varies, orientations of the X-axis direction, the Y-axis direction, and the Z-axis direction thereby vary in accordance with the orientation of the sensor 300. X-axis directions include both a direction expressed by a given arrow and an opposite direction with respect to the direction. Y-axis directions include both the direction expressed by a given arrow and an opposite direction with respect to the direction. Z-axis directions include both the direction expressed by a given arrow and an opposite direction with respect to the direction.

The sensor 300 can detect a change in a positional relationship between the first input unit 50 and the second input unit 60 in accordance with the force that is applied to the force input unit 10. The sensor 300 can detect the moment Mz in accordance with changes in torsional movement about the Z-axis. The Z-axis is an example of a first axis. The sensor 300 may detect the moment My in accordance with changes in torsional movement about the Y-axis. The sensor 300 may detect the moment Mx in accordance with changes in torsional movement about the X-axis.

### Effects of Input Device According to First Embodiment

The input device 100 according to the first embodiment includes the force input unit 10 continuous along the Z-axis direction (first direction), the detection unit 20 coupled to the force input unit 10 in the Z-axis direction, and the sensor 300 mounted on the detection unit 20 and capable of detecting a force acting on the detection unit 20. The detection unit 20 includes the sensor mount 40 having the plane 41 (first plane) that is along the Z-axis direction and the Y-axis direction (second direction) intersecting each other. The detection unit 20 also includes the first input unit 50 and the second input unit 60 coupled to the sensor mount 40. The first input unit 50 and the second input unit 60 respectively include planes 51 and 61 (second planes) that are disposed on both sides of the sensor 300 and that face the sensor in the Z-axis direction.

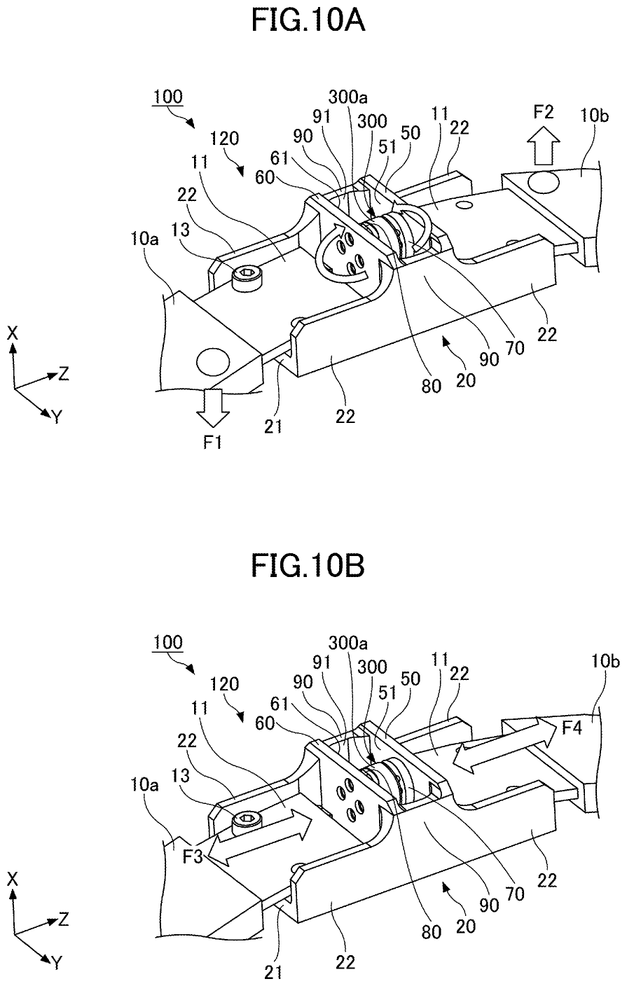

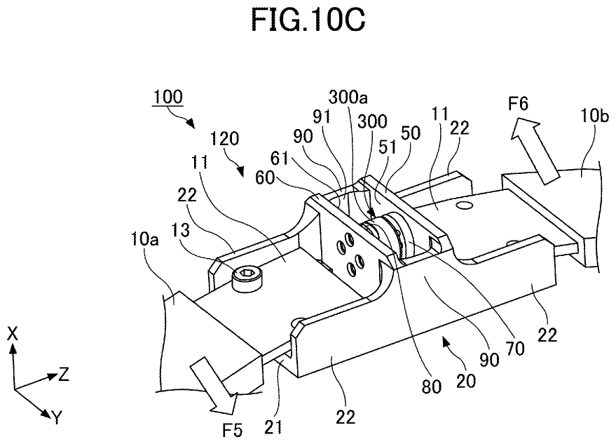

FIGS. 10A to 10C are diagrams showing examples of force detection by the input device according to the first embodiment. As shown in FIG. 10A, a force F1 in a negative X-axis direction is applied toward a positive position on the Y-axis from a centerline of a force input unit 10a. Also, for the other force input unit 10b, a force F2 in a positive X-axis direction is applied toward a negative position on the Y-axis from a centerline of the force input unit 10b. As a result, a clockwise force is applied to the second input unit 60, and a counterclockwise force is applied to the first input unit 50. That is, a positional relationship between the first input unit 50 and the second input unit 60 changes with respect to the Z-axis direction. The sensor 300 can detect the change in the positional relationship between the first input unit 50 and the second input unit 60. The change occurs in accordance with the torsional movement about the Z axis (first axis). Here, a given direction expressed by a given arrow may be a positive direction, and an opposite direction with respect to the given direction may be a negative direction.

In the input device 100, the force acting on the force input unit 10 is transmitted to the detection unit 20. The sensor 300 detects the deformation of the detection unit 20, detects the moment Mz about the Z-axis, and detects the torsion about the Z-axis.

As shown in FIG. 10B, a force F3 in a positive or negative Z-axis direction is applied to the force input unit 10a. A force F4 in the positive or negative Z-axis direction is applied to the force input unit 10b. As a result, the positional relationship between the first input unit 50 and the second input unit 60 changes with respect to the Z-axis direction, and thus the sensor 300 can detect the change in the position relationship between the first input unit 50 and the second input unit 60 in the Z-axis direction. The change occurs in accordance with the force Fz along the Z axis (first axis).

As shown in FIG. 10C, a force F5 in a positive Y-axis direction and a negative X-axis direction is applied to the entire force input unit 10a. A force F6 in a negative Y-axis direction and a positive X-axis direction is applied to the entire force input unit 10b. That is, the positional relationship between the first input unit 50 and the second input unit 60 changes in each of the X-axis direction and the Y-axis direction. The change occurs in accordance with the force Fx along the X axis (third axis) and the force Fy along the Y axis (second axis).

In the input device 100, the sensor 300 includes the first detection unit 70 and the second detection unit 80. The first detection unit 70 contacts the first input unit 50 in the Z-axis direction. The second detection unit 80 contacts the second input unit 60 in the Z-axis direction. The sensor 300 detects the deformation of the first input unit 50 and the second input unit 60. The sensor 300 can detect the forces Fx, Fy, and Fz and the moments Mx, My, and Mz.

The input device 100 includes the buffer portions 90 that are disposed facing each other in the Y-axis direction when viewed in the Z-axis direction and the X-axis direction (third direction). Each buffer portion 90 extends from the sensor mount 40 in the X-axis direction, and couples the first input unit 50 and the second input unit 60. The first input unit 50 and the second input unit 60 are coupled to each other through the buffer portions 90. In this case, an amount of movement of each of the first input unit 50 and the second input unit 60 is restricted. As a result, because the input device 100 includes the buffer portions 90, overloading of the sensor 300 can be suppressed. Therefore, the sensor 300 can be protected.

In the input device 100, each buffer portion 90 includes the plane 91 (third plane) along the Z-axis direction and the X-axis direction. With use of the buffer portions 90, overloading of the first input 50 and the second input 60 can be alleviated.

In the input device 100, the force input unit 10 has the arcuate shape when viewed in the Y-axis direction. Both end portions 11 of the force input unit 10 are connected to the detection unit 20. A combination of the force input unit 10 and the detection unit 20 has an annular shape.

### Input Device According to Second Embodiment

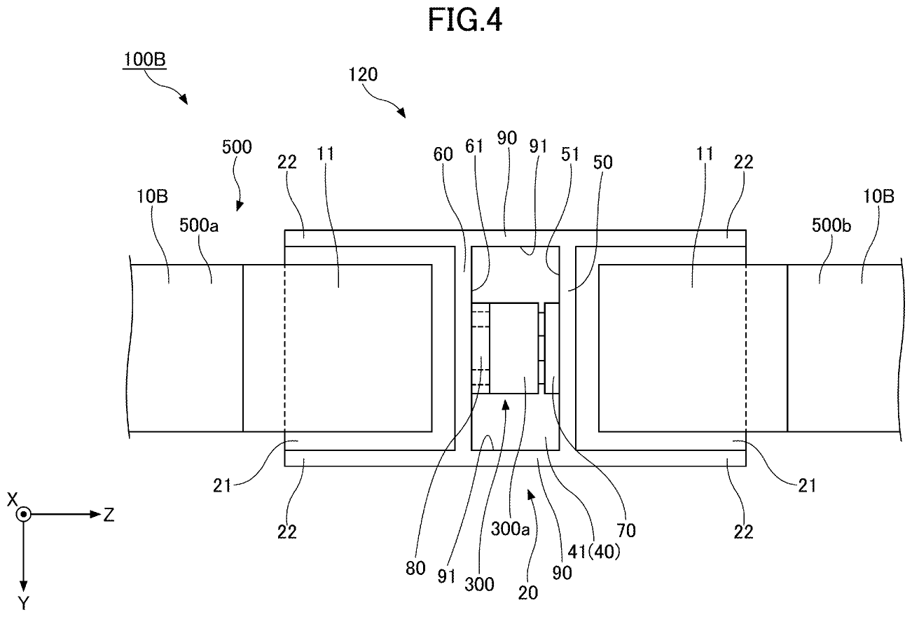

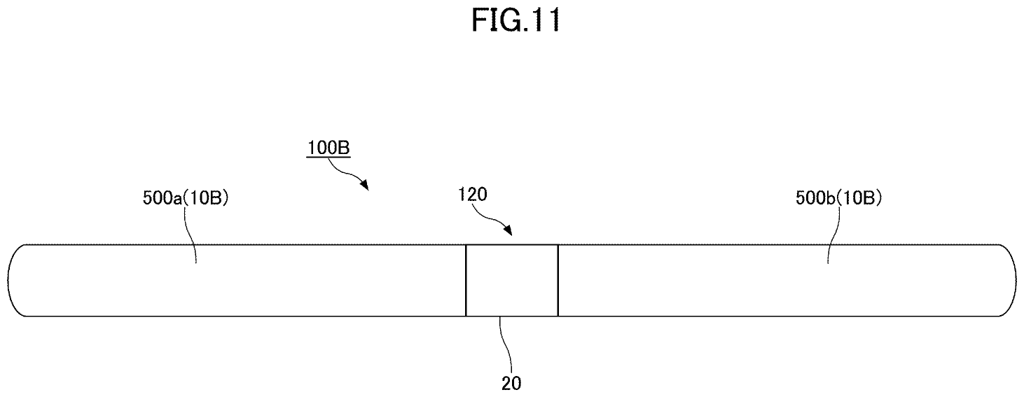

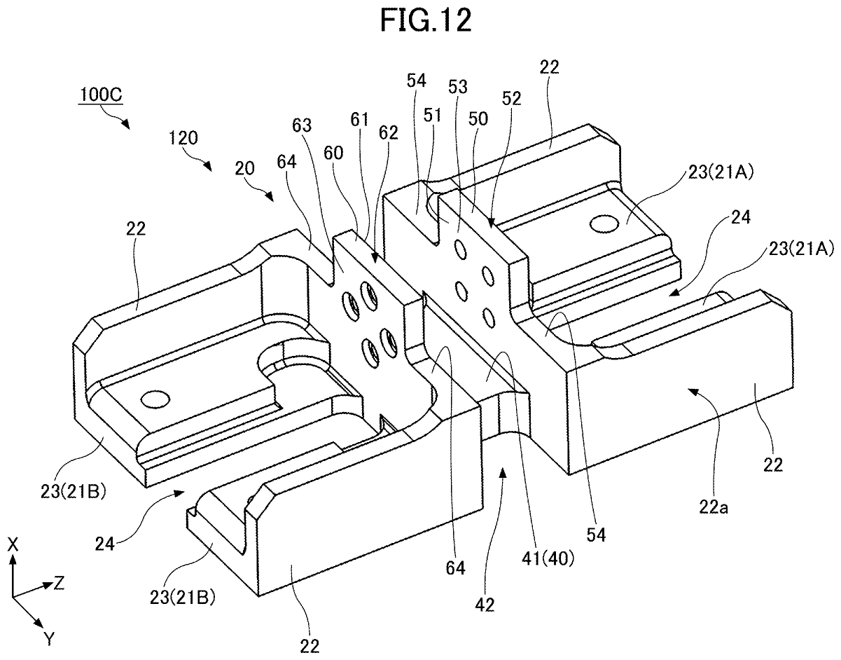

Hereinafter, an input device 100B according to a second embodiment will be described with reference to FIGS. 4 and 11. FIG. 4 is a plan view of the input device 100B according to the second embodiment. FIG. 11 is a diagram showing an application example of the input device 100B according to the second embodiment. The input device 100 according to the first embodiment differs from the input device 100B according to the second embodiment shown in FIG. 4 in that a force input unit 10B that is disposed linearly is provided instead of the force input unit 10 that is disposed in an arcuate pattern. For the input device 100B according to the second embodiment, the same description as described in the input device 100 according to the first embodiment may be omitted.

As shown in FIG. 11, a bar 500 has a first portion 500a and a second portion 500b opposite the first portion 500a. The input device 100B is disposed between the first portion 500a and the second portion 500b. The force input unit 10B has a rod shape, for example. The force input unit 10B may be a portion of the first portion 500a and the second portion 500b in the bar 500. Both end portions 11 of the of the bar 500 may be fixed to the detection unit 20 by respective bolts.

A longitudinal direction of the force input unit 10B refers to the Z-axis direction. The force input unit 10B may be, for example, a portion of a stiffener of a bicycle handle, a machine, or a structure. The force input unit 10B may include a grip that a user can manipulate. By gripping and operating the force input unit 10B, the user can transmit a force to the detection unit 20 through the force input unit 10B. A cross-sectional shape of the force input unit 10B may be circular, rectangular, polygonal, or cylindrical, or alternatively, any other shape may be adopted.

The input device 100B according to the second embodiment has the same effects as described in the input device 100 according to the first embodiment. The input device 100B may include a rod-shaped linear force input unit 10B. In a modified embodiment, the force input unit 10B may be formed by, coupling, for example, multiple linear units at right angles, or the force input unit 10B may be formed to bifurcate into multiple units. The thickness of the force input unit 10B may be constant, or may partially vary.

### Force Sensor Device According to Embodiment

Hereinafter, the force sensor device 301 according to the present embodiment will be described. The force sensor device 301 is applicable to the above sensor 300. The force sensor device 301 according to the present embodiment can detect the force Fx in the X-axis direction, the force Fy in the Y-axis direction, and the force Fz in the Z-axis direction. The force sensor device 301 can detect the moment Mx to cause rotation about the X-axis, the moment My to cause rotation about the Y-axis, and the moment Mz to cause rotation about the Z-axis.

### Schematic Configuration of Force Sensor Device

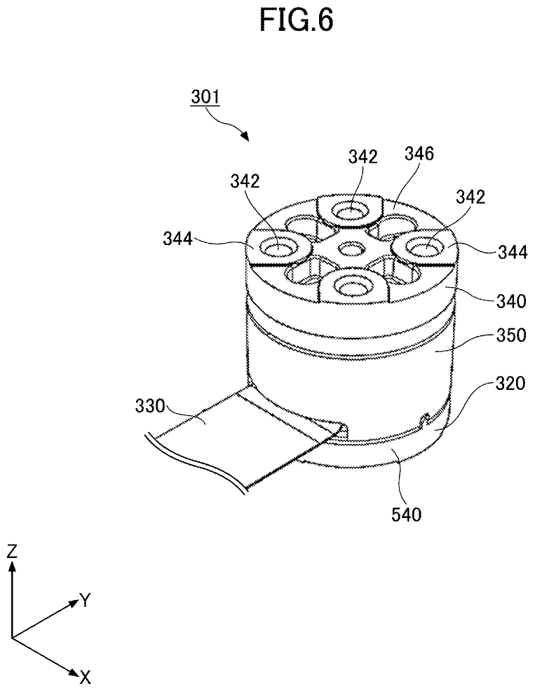

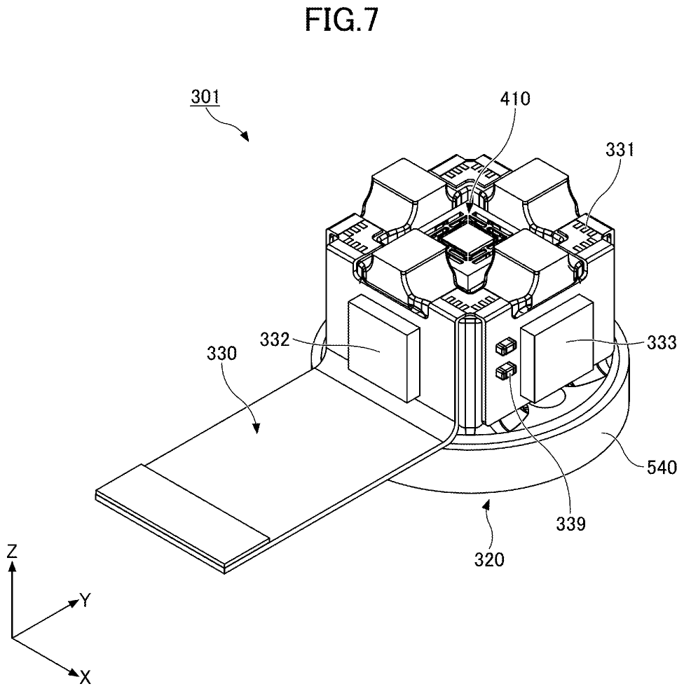

FIG. 6 is a perspective view of the force sensor device 301 according to the embodiment. FIG. 7 is a perspective view of a sensor chip 410, a flexible substrate 330, and a strain-generating unit 320.

The force sensor device 301 according to the present embodiment shown in FIGS. 6 and 7 includes the sensor chip 410, the strain-generating unit 320, the flexible substrate 330, a receiver 340, and a cover 350. The receiver (first detection unit 70) 340 is disposed so as to be in contact with the first input unit 50. The receiver 340 corresponds to the first input unit 50 shown in FIGS. 1 to 4. The strain-generating unit 320 includes a connection portion 540 (second detection unit 80) coupled to the second input unit 60. The force sensor device 301 is, for example, a compact force sensor device. The cover 350 has a cylindrical shape. A portion of the strain-generating unit 320 and the sensor chip 410 are housed in the cover 350. The flexible substrate 330 is connected to the sensor chip 410.

### Receiver

The force sensor device 301 is disposed between the first input unit 50 and the second input unit 60 in the Z-axis direction. The receiver 340 of the force sensor device 301 is connected to a plane 51 of the first input unit 50. The receiver 340 has a disk shape, for example. Multiple screw holes 342 are formed in the receiver 340.

Multiple contact surfaces 344 in contact with the first input unit 50 are formed on a top surface of the receiver 340. The top surface of the receiver 340 is disposed at a position apart from the cover 350 in the Z-axis direction. The contact surfaces 344 are respectively formed around the screw holes 342. Here, the receiver 340 and the first input unit 50 are connected to each other by the screws that are inserted in the respective screw holes 342. The contact surfaces 344 are formed as stepped surfaces each of which protrudes outward in the Z-axis direction from a mounting surface 346 that is around a corresponding contact surface 344. Each contact surface 344 has a predetermined surface roughness. The receiver 340 can be formed of stainless steel, for example. The receiver 340 may be fixed to the strain-generating unit 320 by welding, for example.

### Connection Portion

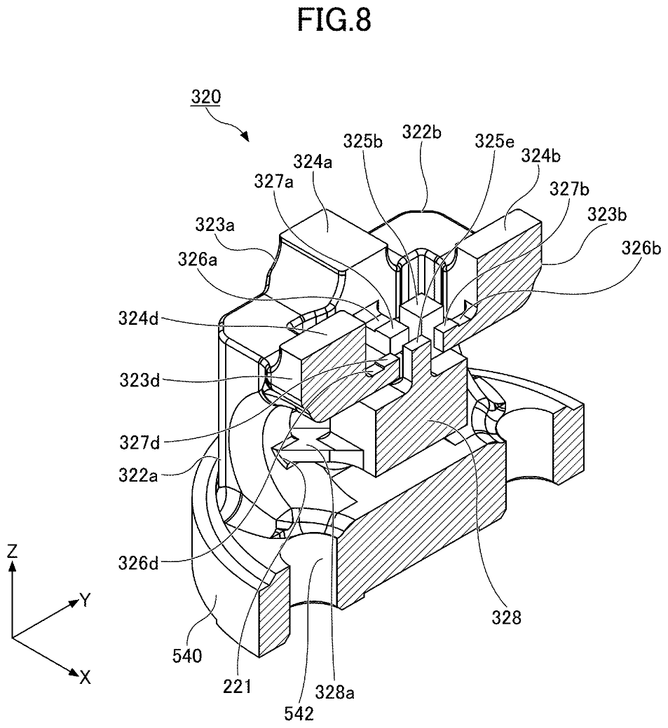

The force sensor device 301 is disposed facing the plane 61 of the second input unit 60 in the Z-axis direction. The second input unit 60 is disposed on an opposite side of the force sensor device 301 from the first input unit 50 in the Z-axis direction. The connection portion 540 of the force sensor device 301 is connected to the second input unit 60. The connection portion 540 has a disk shape, for example. As shown in FIG. 8, the screw holes 542 are formed in the connection portion 540. The connection portion 540 is attached to the second input unit 60 by a screw that is inserted in the screw hole 542.

Multiple contact surfaces in contact with the plane 61 of the second input unit 60 are formed at a bottom surface of the connection portion 540. The bottom surface of the connection portion 540 is disposed at a position apart from the cover 350 in the Z-axis direction. The contact surfaces are formed around the respective screw hole 542.

### Sensor Chip

The sensor chip 410 is mounted on the strain-generating unit 320 as shown in FIG. 7. The sensor chip 410 is bonded to an upper-surface side of the strain-generating unit 320 so as not to protrude from the strain-generating unit 320. The sensor chip 410 is disposed close to the receiver 340 in the Z-axis direction.

The sensor chip 410 includes a micro electro mechanical systems (MEMS) sensor chip that performs detection with respect to 6 axes, by using one chip. The sensor chip 410 is formed by a semiconductor substrate such as an SOI (silicon on insulator) substrate. The planar shape of the sensor chip 110 can have, for example, a length square of about 3000 μm. The configuration of the sensor chip 410 is described in Japanese Unexamined Patent Application Publication No. 2018-185296, and the detailed description of the sensor chip 410 is omitted.

### Flexible Substrate

The flexible substrate 330 receives and outputs signals with respect to the sensor chip 410. The flexible substrate 330 is connected, at one end, to the sensor chip 410 and is disposed in the cover 350. The other end of the flexible substrate 330 is appropriately bent and is disposed on an upper surface and a side surface of the strain-generating unit 320. Each electrode 331 of the flexible substrate 330 is electrically connected to the sensor chip 410 by a bonding wire, for example.

Active components 332 and 333 are mounted on the flexible substrate 330. Each of the active components 332 and 333 includes an IC (AD converter) that converts an analog signal to a digital signal. Each of the active components 332 and 333 converts, for example, the analog signal from a bridge circuit that detects the forces Fx, Fy, and Fz output from the sensor chip 410, into the digital signal. The flexible substrate 330 includes one or more passive component 339. Each passive component 339 includes a resistor and a capacitor that are each connected to the active components 332 and 333.

### Strain-Generating Unit

Hereinafter, the strain-generating unit 320 will be described with reference to FIG. 8. FIG. 8 is a cross-sectional perspective view of the strain-generating unit 320 of the force sensor device 301.

The connection portion 540 is a portion of the strain-generating unit 320, and is disposed along the Z-axis direction and at a position distant from the receiver 340. A portion of the strain-generating unit 320 that is situated above the connection portion 540 is covered with the cover 350 as described above.

The strain-generating unit 320 includes the above connection portion 540 and a block body 328 that is disposed above the connection portion 540 and that serves as a sensor-chip mounted unit for mounting the sensor chip 410. The strain-generating unit 320 also includes columns 322a that are disposed around the block body 328, and multiple beams 323a, 323b, and 323d each of which connects columns 322a.

The columns 322a are disposed to be uniform (point symmetric) with respect to a center of the connection portion 540, when viewed in the Z-axis direction. The columns 322a protrude in the Z-axis direction from the connection portion 540 that is a base. In the Z-axis direction, an opposite end of each column 322a from the connection portion 540 is connected to a corresponding beam among the beams 323a, 323b, and 323d.

The block body 328 is disposed at a center of the columns 322a when viewed in the Z-axis direction. The block body 328 is, for example, a square when viewed in the Z-axis direction. The block body 328 is not limited to the square when viewed in the Z-axis direction, and may have any other polygon, or may be circular. The block body 328 is thicker than the column 322a. A length of the block body 328 in the Z-axis direction is smaller than the column 322a.

The block body 328 is disposed at a position apart from the connection portion 540 in the Z-axis direction. The block body 328 is connected to the columns 322a through respective connection beams 328a each of which extends in a radial direction of a virtual circle as viewed in the Z-axis direction. The connection beams 328a connect each corner of the block body 328 to a corresponding column, among the columns 322a and 322b, that faces the corner as viewed in the Z-axis direction.

Each connection beam 328a may be connected in the Z-axis direction below a middle portion of a corresponding column among the columns 322a and 322b. A thickness of each connection beam 328a is narrower and thinner than each of the columns 322a and 322b and the beams 323a. Thus, stiffness of the connection beam 328a can be less than that of the columns 322a and 322b and the beams 323a, 323b, and 323d.

Each of the beams 323a, 323b, and 323d includes a portion that extends in the Z-axis direction toward an opposite side from the connection portion 540. The beams 323a, 323b, and 323d further extend toward an opposite side from the connection portion 540, as compared to the columns 322a and 322b. Input units 324a, 324b, and 324d are each formed on a surface of the beam 323a opposite the connection portion 540 in the Z-axis direction. In the Z-axis direction, the input units 324a, 324b, and 324d are each disposed at the closest position to the receiver 340 and at the most distant position from the connection portion 540. When viewed in the Z-axis direction, the input units 324a, 324b, and 324d are each disposed at an intermediate position between adjacent columns 322a and 322b.

The strain-generating unit 320 includes beams 326a, 326b, and 326d that extend radially inward from the respective beams 323a, 323b, and 323d. Each of the beams 326a, 326b, and 326d extends toward a position overlapping the block body 328 when viewed in the Z-axis direction. First contact portions 327a, 327b, and 327d are respectively formed at ends of the beams 323a, 323b, and 323d. The first contact portions 327a, 327b, and 327d have respective contact surfaces in contact with the sensor chip 410. The first contact portions 327a, 327b, and 327d are respectively coupled to the input units 324a, 324b, and 324d via the beams 326a, 326b, and 326d. The first contact portions 327a, 327b, and 327d are disposed at respective positions overlapping the block body 328 as viewed in the Z-axis direction. The first contact portions 327a, 327b, and 327d are separated from the block body 328 in the Z-axis direction. The first contact portions 327a, 327b, and 327d are each disposed on an opposite side of the block body 328 from the connection portion 540 in the Z-axis direction.

Further, the block body 328 includes second contact portions 325b and 325e that protrude in a direction opposite the connection portion 540 in the Z-axis direction. The second contact portions 325b and 325e include respective surfaces in contact with the sensor chip 410. The second contact portion 325e is disposed at a center of the block body 328 as viewed in the Z-axis direction. The second contact portions 325a, 325b, and 325d are each disposed at a position corresponding to a corresponding corner of the block body 328 as viewed in the Z-axis direction. Each of the first contact portions 327a, 327b, and 327d is disposed between second contact portions 325b in each of the X-axis direction and the Y-axis direction.

In the force sensor device 301, when a load is applied to the receiver 340 (first detection unit 70) and the connection portion 540 (second detection unit 80), relative displacement between sets of first contact portions 327a, 327b, and 327d and sets of second contact portions 325b and 325e that are in contact with the sensor chip 410 is caused.

Similarly, when a load is not applied to the receiver 340 (first detection unit 70) and is applied to the connection portion 540 (second detection unit 80), the relative displacement between sets of first contact portions 327a, 327b, and 327d and sets of second contact portions 325b and 325e that are in contact with the sensor chip 410 is caused. Similarly, when a load is applied to the receiver 340 (first detection unit 70) and is not applied to the connection portion 540 (second detection unit 80), the relative displacement between sets of first contact portions 327a, 327b, and 327d and sets of second contact portions 325b and 325e that are in contact with the sensor chip 410 is caused.

The sensor chip 410 detects the relative displacement between the sets of the first contact portions 327a, 327b, 327d and the sets of the second contact portions 325a, 325b, 325e to thereby detect (be able to detect) the force Fx, the force Fy, the force Fz, the moment Mx, the moment My, and the moment Mz. The force sensor device 301 according to the present embodiment is a well-known technique.

The sensor 300 that is mounted on the input device 100 is not limited to the force sensor device 301, and may be a force sensor device having any other structure.

### Input Device According to Third Embodiment

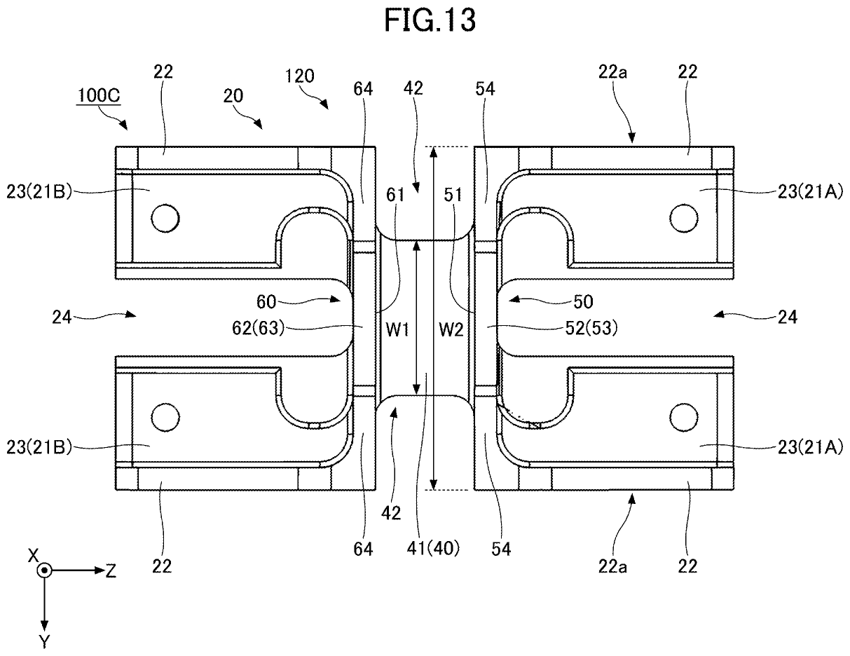

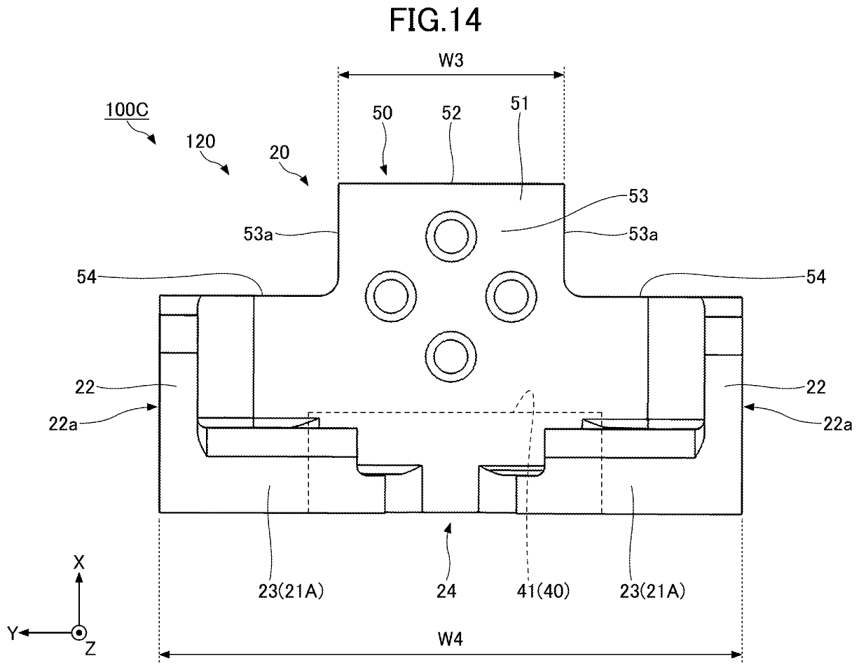

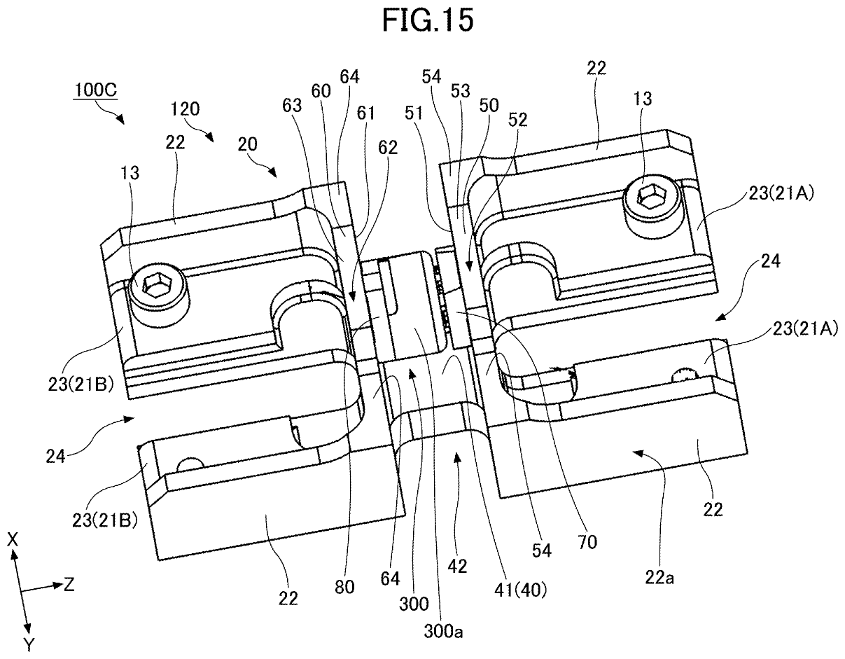

Hereinafter, an input device 100C according to a third embodiment will be described with reference to FIGS. 12 to 15. FIG. 12 is a perspective view of an example of the input device according to the third embodiment. FIG. 13 is a plan view of an example of the input device according to the third embodiment. FIG. 14 is a front view of an example of the input device according to the third embodiment. FIG. 15 is a perspective view of an example of the detection unit 20 on which the sensor 300 is mounted according to the third embodiment. The first detection unit 70, the second detection unit 80, and the sensor 300 are not shown in FIGS. 12 to 14.

The input device 100C according to the third embodiment shown in FIGS. 12 to 15 differs from the input device 100 according to the first embodiment shown in FIGS. 1 to 4 in that the input device 100C has the following items: (i) a buffer portion 90 is not formed, (ii) recesses 42 are formed, (iii) slits 24 are formed in respective bottom plates 21A and 21B, (iv) both side portions of the first input unit 50 in the Y-axis direction are cut off, and (v) both side portions of the second input unit 60 in the Y-axis direction are cut off. In the third embodiment, the similar description to that provided in the above first and second embodiments may be omitted.

### Sensor Mount 40

The sensor mount 40 couples the first input unit 50 and the second input unit 60 in the Z-axis direction. The sensor mount 40 has a plate shape, for example. A plate thickness direction of the sensor mount 40 is along the X-axis direction. A space is formed between the sensor mount 40 and the sensor 300 in the X-axis direction. A width W1 of the sensor mount 40 along the Y-axis direction is larger than, for example, a width of the sensor 300 along the Y-axis direction. The width W1 of the sensor mount 40 shown in FIG. 15 may be smaller than the width of the sensor 300, or may be the same as the width of the sensor 300. The width W1 of the sensor mount 40 is smaller than a width W2 of the first input unit 50 along the Y-axis direction. A width W of the first input unit 50 may correspond to a length between outer surfaces 22a in a pair of side plates 22 that are opposed to each other in the Y-axis direction.

### Recess 42

The recesses 42 are formed on respective sides of the sensor mount 40 in the Y-axis direction. The sensor mount 40 has a plate shape. Each recess 42 is formed to be recessed inward from the side plate 22 in the Y-axis direction. The recess 42 is formed between the given side plates 22 making a pair in the Z-axis direction. The sensor mount 40 is exposed when viewed in the Y-axis direction. The sensor mount 40 is not covered with the buffer portion 90 when viewed in the Y-axis direction. With use of the recesses 42, the width W1 of the sensor mount 40 is smaller than the width W2 of the first input unit 50 along the Y-axis direction.

### Bottom Plates 21A and 21B

The input device 100C includes bottom plates 21A and 21B. The bottom plate 21A is an example of a first bottom plate, and the bottom plate 21B is an example of a second bottom plate. The bottom plate 21A extends from the first input unit 50 toward an opposite side from the second input unit 60 in the Z-axis direction. The bottom plate 21B extends from the second input unit 60 toward an opposite side from the first input unit 50 in the Z-axis direction. A plate thickness direction of each of the bottom plates 21A and 21B is along the X-axis direction.

### Pair of Portions 23 in Each of Bottom Plates 21A and 21B

Each of the bottom plates 21A and 21B includes a pair of portions 23 that are spaced apart in the Y-axis direction.

### Slit 24

The respective slits 24 are formed in the bottom plates 21A and 21B. Each slit 24 is formed between the portions 23 in the Y-axis direction. A length of the slit 24 along the Z-axis direction may be the same as a length of each of the bottom plates 21A and 21B in the Z-axis direction. A width of each slit 24 along the Y-axis direction may be smaller than a width of the portion 23 along the Y-axis direction.

### First Input Unit 50 and Second Input Unit 60

The first input unit 50 has a main body 53 and a pair of lateral units 54. The second input unit 60 has a main body 63 and a pair of lateral units 64. The main bodies 53 and 63 face each other in the Z-axis direction. The sensor 300 is disposed between the main bodies 53 and 63. The main body 53 includes the plane 51, and the main body 63 includes the plane 61. The main body 53 is disposed at a middle portion of the first input unit 50 in the Y-axis direction, and the main body 63 is disposed at a middle portion of the second input unit 60 in the Y-axis direction. Each of the main bodies 53 and 63 is further protruded upward in the X-axis direction, as compared to the side plate 22.

The lateral units 54 protrude from the main body 53 in the respective Y-axis directions. Each lateral unit 54 in the X-axis direction is shorter than the main body 53 in the X-axis direction. In other words, a portion of the main body 53 protrudes from the pair of lateral units 54. An upper surface 52 of the main body 53 is disposed above the upper surface of the pair of lateral units 54. Each lateral unit 54 may be formed by cutting the first input unit 50 and positioning the upper surface of the lateral unit 54 lower than the upper surface 52. The upper surface of each lateral unit 54 may have a height that is substantially the same as that of the upper surface of the pair of lateral plates 22, or the upper surface of each lateral unit 54 may be disposed slightly higher than the upper surface of each lateral plate 22.

The lateral units 64 are formed so as to protrude from both sides of the main body 63 in the respective Y-axis directions. The length of each lateral unit 64 in the X-axis direction is smaller than the length of the main body 63 in the X-axis direction. In other words, a portion of the main body 63 protrudes from the pair of lateral units 64. The upper surface 62 of the main body 63 is disposed above the upper surface of the pair of lateral units 64. Each lateral unit 64 may be formed by cutting the second input unit 60 and positioning the upper surface of the lateral unit 64 lower than the upper surface 52. The upper surface of each lateral unit 64 may have a height that is substantially the same as that of the upper surface of the pair of lateral plates 22, or may be disposed slightly higher than the upper surface of each lateral plate 22.

### Widths W3 and W4 of First Input Unit 50

As shown in FIG. 14, a width W3 of a portion of the first input unit 50 that is farther from the sensor mount 40 is smaller than a width W4 of a portion of the first input unit 50 that is close to the sensor mount 40. The width W3 and the width W4 are widths along the Y-axis direction. The width W3 may correspond to a length between the side surfaces 53a of the main body 53.

Similarly, a width of a portion of the second input unit 60 that is farther from the sensor mount 40 is smaller than the width W4 of a portion of the second input unit 60 that is close to the sensor mount 40.

### Effects of Input Device 100C According to Third Embodiment

The input device 100C according to the third embodiment has similar effects to those in the input device 100 according to the first embodiment. In the input device 100C, the width W1 of the

sensor mount 40 is smaller than the width W2 of each of the first input unit 50 and the second input unit 60. In the input device 100C, the recesses 42 are formed on the respective sides of the sensor mount 40. As a result, the sensor mount 40 is easily deformed, and the sensor 300 easily detects relative deformation about the Z-axis, with respect to the first input unit 50 and the second input unit 60.

In the input device 100C, the slits 24 are formed in the bottom plates 21A and 21B. With this arrangement, the bottom plates 21A and 21B, and the side plates 22 can easily deform. Therefore, the sensor 300 easily detects the relative deformation about the Z axis, with respect to the first input unit 50 and the second input unit 60.

In the input device 100C, the width W3 of each of the first input unit 50 and the second input unit 60 that is farther from the sensor mount 40 is smaller than the width W4 of each of the first input unit 50 and the second input unit 60 that is close to the sensor mount 40. As a result, the main bodies 53 and 63 of the first input unit 50 and the second input unit 60 can easily deform. With this arrangement, the sensor 300 easily detects the relative deformation about the Z axis, with respect to the first input unit 50 and the second input unit 60.

The present disclosure is not limited to the above embodiments. It is understood that any component(s) is added in the embodiments. Various changes, omissions, and combinations in the form of the embodiments may be made without departing from the scope set forth in the present disclosure.

The present disclosure can provide an input device and a force detector that are capable of detecting the torsion of the first axis extending in the first direction.

What is claimed is:

1. An input device comprising:
a force input unit continuous along a first direction;
a detection unit coupled to the force input unit in the first direction; and
a sensor provided on the detection unit and configured to detect a force on the detection unit, the detection unit including
a sensor mount on which the sensor is provided, the sensor mount including a first plane along the first direction and a second direction intersecting the first direction, and
a first input unit and a second input unit disposed on respective sides of the sensor in the first direction, each of the first input unit and the second input unit being coupled to the sensor mount, and including a second plane facing the sensor,
wherein the sensor is configured to detect a change in a positional relationship between the first input unit and the second input unit, and
wherein the positional relationship changes in accordance with torsional movement about a first axis along the first direction.

2. The input device according to claim 1, wherein the sensor includes a first detection unit and a second detection unit,
wherein the first detection unit contacts the first input unit in the first direction, and
wherein the second detection unit contacts the second input unit in the first direction.

3. The input device according to claim 1, wherein the detection unit includes buffer portions facing each other in the second direction when viewed in a third direction intersecting the first direction and the second direction, and
wherein each of the buffer portions extends from the sensor mount in the third direction, and couples the first input unit and the second input unit.

4. The input device according to claim 3, wherein each of the buffer portions includes a third plane along the first direction and the third direction.

5. The input device according to claim 1, wherein the force input unit has an arcuate shape when viewed in the second direction,
wherein the force input unit includes both end portions at which the detection unit is coupled, and
wherein the force input unit and the detection unit have an annular shape.

6. The input device according to claim 1, wherein in the second direction, the sensor mount is narrower than each of the first input unit and the second input unit.

7. The input device according to claim 1, further comprising:
a first bottom plate extending from the first input unit toward an opposite side from the second input unit; and
a second bottom plate extending from the second input unit toward an opposite side from the first input unit,
wherein a thickness direction of each of the first bottom plate and the second bottom plate is along a third direction intersecting the first direction and the second direction, and
wherein each of the first bottom plate and the second bottom plate includes a pair of portions that are spaced apart in the second direction.

8. The input device according to claim 1,
wherein in the second direction, a width of a portion of the first input unit farther from the sensor mount is smaller than a width of a portion of the first input unit close to the sensor mount, and
wherein in the second direction, a width of a portion of the second input unit farther from the sensor mount is smaller than a width of a portion of the second input unit close to the sensor mount.

9. A force sensor comprising:
a detection unit coupled to a force input unit in a first direction; and
a sensor provided on the detection unit and configured to detect a force on the detection unit, the detection unit including
a sensor mount on which the sensor is provided, the sensor mount including a first plane along the first direction and a second direction intersecting the first direction, and
a first input unit and a second input unit disposed on respective sides of the sensor in the first direction, each of the first input unit and the second input unit being coupled to the sensor mount, and including a second plane facing the sensor,
wherein the sensor is configured to detect a change in a positional relationship between the first input unit and the second input unit, and
wherein the positional relationship changes in accordance with torsional movement about a first axis along the first direction.

10. The force sensor according to claim 9, further comprising:
a first detection unit disposed between the sensor and the first input unit in the first direction, and contacting the sensor and the first input unit; and
a second detection unit disposed between the sensor and the second input unit in the first direction, and contacting the sensor and the second input unit.

11. The force sensor according to claim 9, wherein the detection unit includes buffer portions facing each other in the second direction when viewed in a third direction intersecting the first direction and the second direction, and
wherein each of the buffer portions extends from the sensor mount in the third direction, and couples the first input unit and the second input unit.

12. The force sensor according to claim 11, wherein each of the buffer portions includes a third plane along the first direction and the third direction.

13. The force sensor according to claim 9, wherein in the second direction, the sensor mount is narrower than each of the first input unit and the second input unit.

14. The force sensor according to claim 9, further comprising:
a first bottom plate extending from the first input unit toward an opposite side from the second input unit; and
a second bottom plate extending from the second input unit toward an opposite side from the first input unit,
wherein a thickness direction of each of the first bottom plate and the second bottom plate is along a third direction intersecting the first direction and the second direction, and
wherein each of the first bottom plate and the second bottom plate includes a pair of portions that are spaced apart in the second direction.

15. The input device according to claim 9,
wherein in the second direction, a width of a portion of the first input unit farther from the sensor mount is smaller than a width of a portion of the first input unit close to the sensor mount, and
wherein in the second direction, a width of a portion of the second input unit farther from the sensor mount is smaller than a width of a portion of the second input unit close to the sensor mount.
